(19) United States
(12) Patent Application Publication
(10) Pub. No.: US 2011/0139270 A1
(43) Pub. Date: Jun. 16, 2011

(54) THERMAL SWITCHED COOLING ORIFICE FOR ACTUATION SYSTEMS

(76) Inventor: Leo J. Veilleux, JR., Wethersfield, CT (US)

(21) Appl. No.: 12/635,921

(22) Filed: Dec. 11, 2009

(51) Int. Cl. F16K 17/38; F01B 29/08

(52) U.S. Cl. 137/468; 60/516

(57) ABSTRACT

An actuator includes features that reduce the energy drawn from the engine by reducing and/or eliminating the flow requirement during normal operating conditions. A normally closed cooling orifice opens responsive to an elevated temperature to allow cooling fluid flow. Once the temperature returns to normal ranges, the thermally expanding material retracts and the valve returns to a closed position to stop cooling flow.

### BACKGROUND

This disclosure generally relates to hydraulic actuators for use in aircraft applications. More particularly, this disclosure relates to a hydraulic actuator including features for cooling in high temperature conditions.

Actuators for use in aircraft applications are required to survive and operate at high temperatures. Further, actuators utilized in some application are required to survive exposure to fire and flame without adding to a potential fire. Current methods of protecting actuators include the use of fire blankets or shielding around the actuator. Other methods utilize a continuous cooling flow through the actuator. The use of fire shields requires additional valuable space for the actuator. Fire blankets can in some instances absorb undesirable fluids, and continuous cooling features reduce overall engine operating efficiencies. A pump is powered by power generated by an aircraft engine. The larger displacement required by the pump, the more energy that is drawn from the aircraft engine. The larger pump can also cause a larger thermal load that in turn requires further thermal management devices. Even the use of a variable pump increases the load on the engine that results in decreases in desired efficiency.

Accordingly, improved methods of meeting every more stringent actuator thermal operating requirements are desirable.

### SUMMARY

A disclosed actuator includes features that reduce the energy drawn from the engine by reducing and/or eliminating the flow requirement during normal operating conditions. The actuator includes a normally closed cooling orifice that opens responsive to elevated temperatures to allow cooling fluid flow. A ball valve prevents flow through the cooling orifice during normal temperature operating conditions. In response to an increase in temperature a thermally expanding material within the valve opens an orifice to allow cooling fluid flow. Once the temperature returns to normal ranges, the thermally expanding material retracts and the valve returns to a closed position to stop cooling flow.

These and other features disclosed herein can be best understood from the following specification and drawings, the following of which is a brief description.

### BRIEF DESCRIPTION OF THE DRAWINGS

FIG. 1 is a schematic view of an aircraft including control surfaces.

FIG. 2 is a schematic view of an actuator for moving a control surface.

FIG. 3 is a schematic cross-section of an example actuator including selective cooling features.

FIG. 4A is a schematic view of an example thermal switched cooling orifice in a closed position.

FIG. 4B is a schematic view of the example thermal switched cooling orifice in an opened position.

FIG. 5 is a schematic view of another example actuator including selective cooling features.

FIG. 6 is a schematic view of yet another example actuator including selective cooling features.

### DETAILED DESCRIPTION

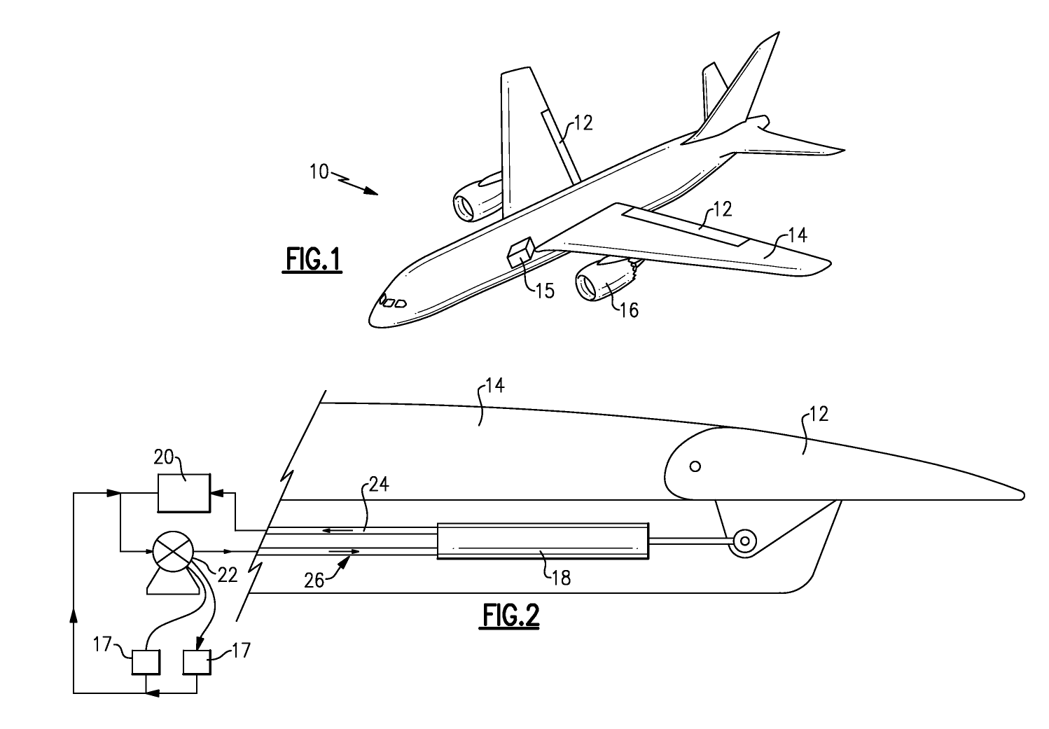

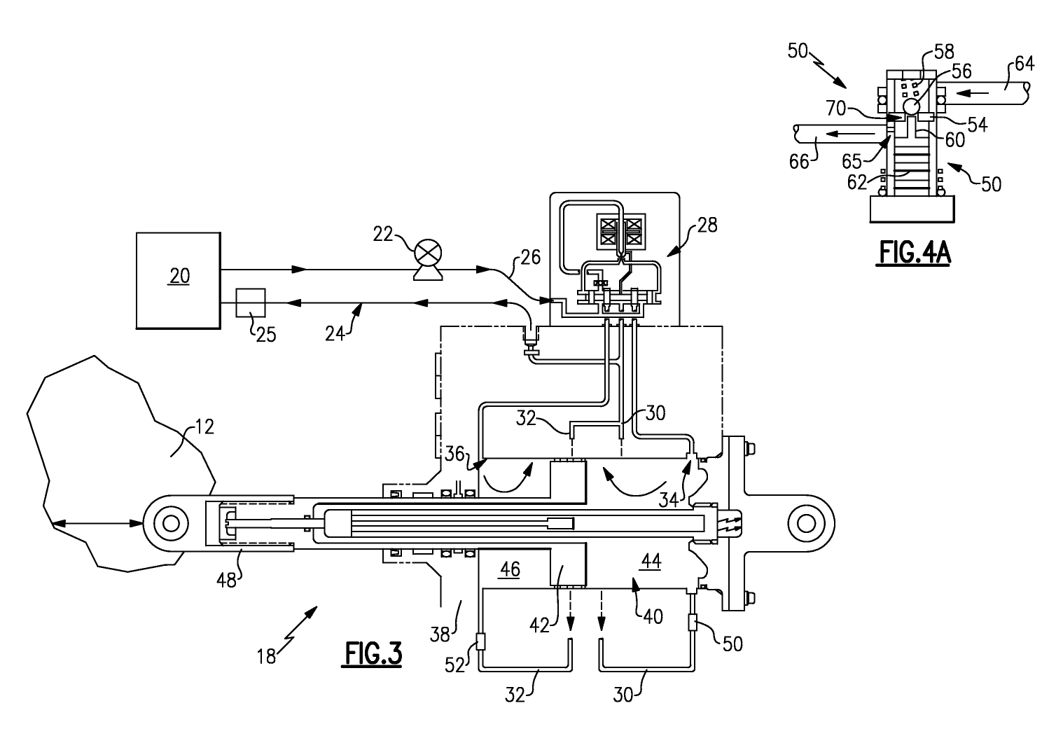

Referring to FIGS. 1 and 2 an airplane 10 includes a wing 14 and movable control surfaces 12. The control surfaces 12 are operated by actuators 18 that utilize pressurized fluid flow to move the actuator 18 and thereby the control surface 12. A pump 22 draws fluid from a reservoir 20 and provides that pressurized fluid flow to various systems 17 within the aircraft along with the example actuator 18 and servo control 28 (FIG. 3). The aircraft engine 16 or an auxiliary power unit 15 on board the airplane 10 powers the pump 22.

Actuators on board an aircraft are used for many purposes, such as moving guide vanes or any other variable geometry surface. Such actuators are required to operate under increased thermal conditions, such as for example exposure to a flame or other heat source. Fluid flow is therefore provided to and from the example actuator 18 by way of supply line 26 and return line 24. In this example the fluid flow is fuel that is controlled to power the actuator 18. However, other working fluids, including hydraulic fluid and air are within the contemplation of this disclosure. The pump 22 therefore draws energy produced by the engine 16 or auxiliary power unit 15. The example actuator 18 includes features that reduce the energy required to be drawn from the engine 16 by reducing and/or eliminating the flow requirement during normal operating conditions that do not require cooling fluid flow.

Referring to FIG. 3, the example actuator 18 includes a piston 42 that is movable within a chamber 40 defined within a housing 38. The piston 42 divides the chamber 40 into a first portion 44 and a second portion 46. Each of the portions 44, 46 is supplied with a pressurized fluid through respective control ports 34 and 36. A control valve 28 selectively controls pressurized fluid through the control ports 34 and 36 to cause a desired movement of the piston 42 within the chamber 40. The piston 42 in turn drives a rod 48 along the axis to move the control surface 12. The control valve 28 receives pressurized fluid from the pump 22 and reservoir 20.

A first thermally switched cooling orifice 50 is disposed in fluid communication with the first portion 44 and a second thermally switched cooling orifice 52 is disposed in fluid communication with the second portion 46. The cooling orifices 50, 52 are normally in a closed position preventing the flow of fluid out of the chamber 40. The example cooling orifices 50, 52 are valves that control the flow of fluid. Because the cooling orifices 50, 52 normally prevent the flow of fluid, the pump 22 encounters a lesser load in maintaining a required operating pressure. As appreciated, if a constant flow is provided, the pump 22 must run at a higher power level as compared to a fluid system where no or very little flow is required.

The example orifices 50, 52 are activated responsive to an elevated temperature. In response to an elevated temperature, the orifices 50, 52 open to allow fluid flow through return cooling flow passages 30 and 32. Cooling flow through the cooling passages 30, 32 is returned through the return line 24 to the reservoir 20. A heat exchanger 25 maybe utilized to further cool the returning fluid and further improves the cooling function of the fluid flow.

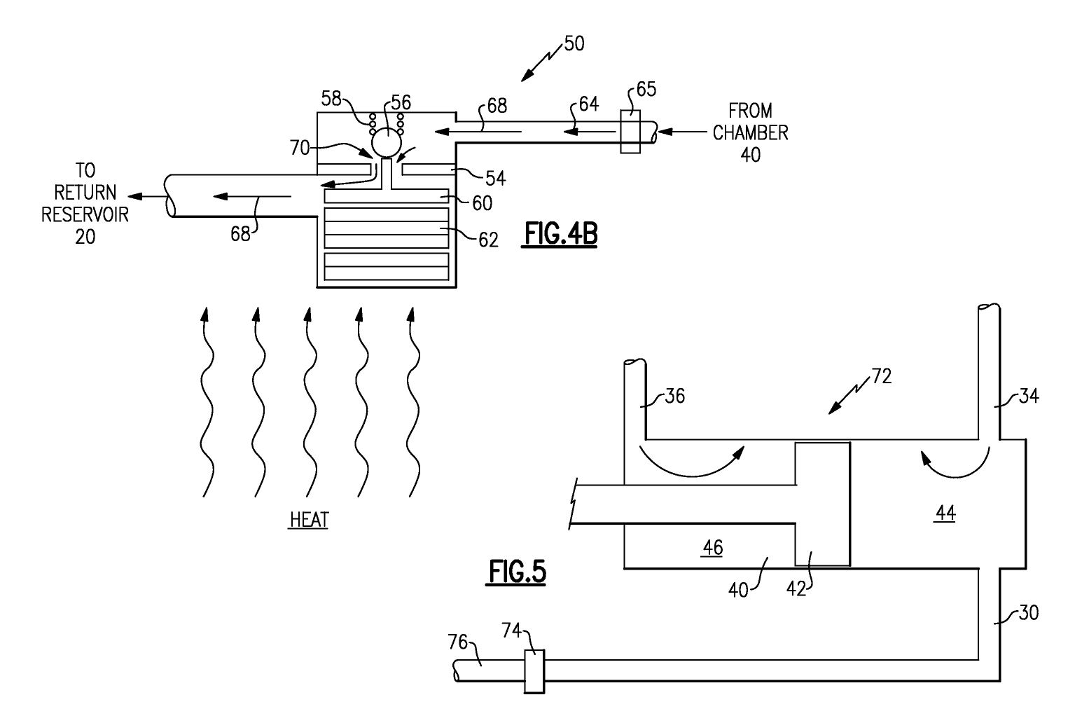

Referring to FIG. 4A, the example cooling orifice 50 includes a ball valve 56 that controls flow through an opening 70 in an orifice plate 54. A spring member 58 holds the ball valve 56 in place. Further, the example ball valve 56 is held against the orifice plate 54 by the pressure through an inlet 64. The inlet 64 is in fluid communication with the chamber 40 and therefore fluid from the inlet 64 is at a higher pressure than fluid in communication with the outlet 66. An orifice 65 is provided to provide precise control of fluid flow through the cooling orifice 50. As appreciated, the example orifice 65 could be provided in either the inlet 64, the outlet 66 or by the opening 70. Although a ball valve 56 is shown, it is within the contemplation of this invention that other valve configurations as are known may also be utilized.

A push rod 60 extends through the opening 70 and is capable of dislodging the valve ball 56 from the orifice plate 54. The push rod 60 is mechanically moved upward through the opening responsive to a thermally expandable material 62 expanding responsive to an elevated temperature. The example expandable material 62 comprises a bimetal combination that expands directionally in response to heat. Expansion of the thermally expandable material 62 is directed to raise the push rod 60 and dislodge the ball valve 56.

Referring to FIG. 4B, the example orifice 50 is schematically shown exposed to a high heat source. The heat causes expansion of the thermally expansive material 62 that moves the push rod 60 upward through the opening 70 to dislodge the ball valve 56. Once the ball valve 56 is dislodged, fluid flow 68 moves through the orifice plate 54 from the chamber 40 and inlet 64. The fluid flow 68 exits through the passage 30 and back through the return line 24 (FIG. 2) to the reservoir 22. The fluid flow 68 effectively maintains the actuator 18 within a desired operating range by removing heat through the increased flow of fluid through the cooling orifices 50, 52.

Referring to FIG. 3, with continued reference to FIGS. 4A and 4B, during normal operation, pressurized fluid is selectively supplied to the portions 44 and 46 of the chamber 40 to effect movement of the piston 40. The control valve 28 governs this operation by controlling the pressures in the portions 44 and 46. Increased pressure in one of the portions 44 and 46 accompanied by a decrease in the other one of the portions causes movement of the piston 42. As appreciated, this movement is determined as required to move the control surface 12 as desired.

During such normal operation, the orifices 50 and 52 prevent flow of fluid out through the cooling flow passages 30, 32. The inflow and outflow of fluid occurs only through the control ports 34 and 36. The only flow that occurs is to facilitate movement of the piston 42.

In the event that the actuator 18 is exposed to heat that elevates the temperature of the actuator 18 and fluid to an elevated range, the orifices 50, 52 open to provide cooling flow. The heat exposure of the actuator 18 causes expansion of the material 62 that moves the push rod 60. The push rod 60 moves the ball valve 56 to allow the flow of cooling fluid out of the portions 44 and 46 of the chamber 40. Fluid flow will then circulate through the chamber 40 to effectively cool the actuator 18.

Once the temperature of the actuator 18 returns to normal operational ranges, the material 62 will return to a position where the push rod 60 is not extended upward through the opening 70. The valve ball 56 returns to the position over the opening 70 to prevent fluid flow. The load on the pump 22 caused by the actuator 18 then returns to a lower level.

Referring to FIG. 5, another actuator 72 includes one orifice 74 that controls cooling fluid flow from the chamber 40. The single orifice 74 is in fluid communication with cooling flow passage 30. The orifice 74 is provided within the return passage 76 to provide cooling flow responsive to increased temperatures. Although one orifice 74 is shown, other numbers of orifices that provide thermally responsive control over cooling flow are within the contemplation of this invention. Further a fixed orifice could be installed to provide additional control of fluid flows separate from the thermal orifice 74.

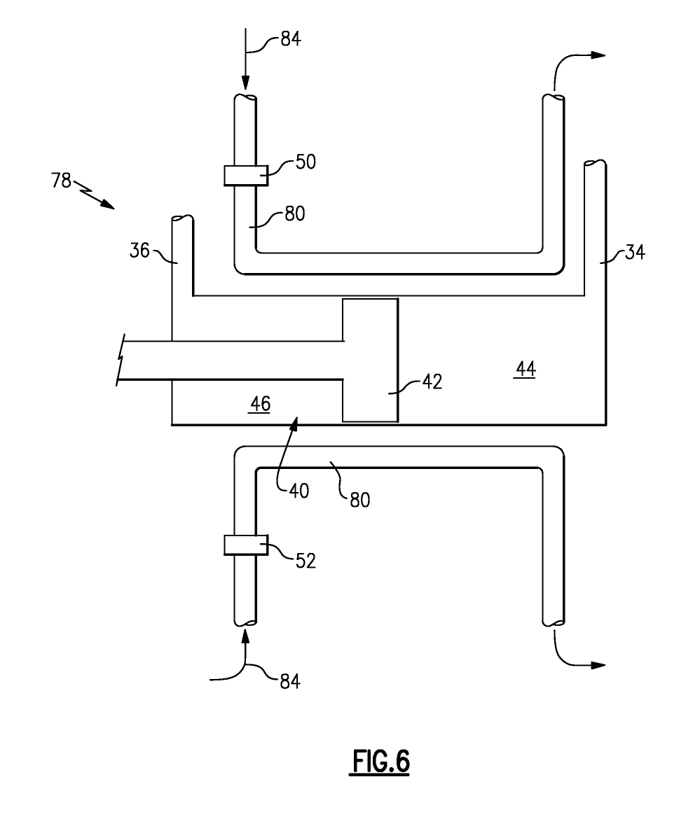

Referring to FIG. 6 another example actuator 78 is schematically shown and includes the piston 42 movable within a chamber 40. Cooling passages 80 are in thermal contact with the chamber 40, but are not in fluid communication. A cooling medium that is separate from the working medium utilized to drive the actuator 78 is controlled by thermally activated orifices 50 and 52. The example cooling medium can be air 84 that moves heat away from the chamber 40 once a temperature reaches a desired level. The control over the cooling medium, cooling air 84 in this instance, reduces the load on a pump or other device required for driving the cooling air during conditions that do not require cooling.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An actuator assembly comprising:
a movable control component;
at least one cooling passage in communication with the movable control component that provides a cooling flow; and
a thermally switched valve disposed within the at least one cooling passage that switches between a closed position to prevent flow through the cooling passage and an open position allowing flow through the cooling passage, the thermally switched valve is operable to allow flow through the cooling passage without external control responsive to exposure at a desired temperature.

2. The actuator assembly as recited in claim 1, wherein the movable control component comprise a piston movable within a chamber.

3. The actuator assembly as recited in claim 2, wherein the thermally switched valve comprises a blocking member over an opening and a temperature responsive member movable to an open position to dislodge the blocking member from the opening at a desired temperature.

4. The actuator assembly as recited in claim 3, wherein the temperature responsive member comprises a material that expands an amount determined to move the blocking member to the open position.

5. The actuator assembly as recited in claim 4, wherein the material comprises a Bimetal expanding material that expands a desired amount responsive to a desired temperature.

6. The actuator assembly as recited in claim 2, including at least one control passage in communication with the chamber that communicates pressure to control movement of the piston within the chamber.

7. The actuator assembly as recited in claim 6, wherein the at least one control passage comprises first and second control passages in communication with the chamber on opposing sides of the piston that provide a control pressure to move the piston within the chamber and the two cooling passages comprises first and second cooling passages disposed on opposing sides of the piston to complete a cooling flow circuit for circulating fluid flow through the chamber.

8. The actuator assembly as recited in claim 7, including a control valve that controls fluid pressure communicated through the first and second control passages to facilitate movement desired movement of the piston.

9. The actuator assembly as recited in claim 1, wherein the desired temperature condition comprises a temperature condition much hotter than temperatures encountered during desired operating conditions.

10. An actuator for moving an aircraft component comprising:
a piston movable within a chamber including a shaft moving an aircraft component to a desired position;
a cooling passage in fluid communication with the chamber for providing a cooling fluid flow through the chamber; and
a thermally switched valve passively operable to prevent cooling fluid flow through the cooling passage at a first temperature condition and allow cooling fluid flow through the cooling passage at a second temperature condition.

11. The actuator as recited in claim 10, wherein the thermally switched valve comprises a thermally expanding material that moves the thermally switched valve to an open position allowing fluid flow through the cooling passage.

12. The actuator as recited in claim 11, wherein the thermally expanding material comprises a Bimetal assembly.

13. The actuator as recited in claim 10, including a ball blocking a flow orifice in a closed position and a movable pintle moving the ball off of the flow orifice in the open position.

14. The actuator as recited in claim 10, wherein the second temperature condition is higher than the first temperature condition.

15. The actuator as recited in claim 10, including first and second control passages in fluid communication with the chamber on either side of the piston for supplying fluid at a pressure determined to move the piston within the chamber, and the cooling passage comprises first and second cooling passages in communication with the chamber on opposing sides of the piston.

16. The actuator as recited in claim 15, including a control valve governing fluid pressures through the first and second control passages.

17. The actuator as recited in claim 16, wherein the cooling passages communicate fluid flow to a fluid reservoir, and a pump supplies fluid from the fluid reservoir to the control valve at a desires pressure.
